(19) United States
(12) Patent Application Publication
(10) Pub. No.: US 2018/0257732 A1
(43) Pub. Date: Sep. 13, 2018

(54) FOOT-CONTROLLED PERSONAL TRANSPORTATION DEVICE

(71) Applicant: Shane Chen, Camas, WA (US)

(72) Inventor: Shane Chen, Camas, WA (US)

(21) Appl. No.: 15/916,985

(22) Filed: Mar. 9, 2018

Related U.S. Application Data
(60) Provisional application No. 62/469,514, filed on Mar. 9, 2017.

(51) Int. Cl. B62K 11/00; B60L 15/20; B60K 7/00

(52) U.S. Cl. CPC B62K 11/007; B62K 1/00; B60K 7/0007; B60L 15/20

(57) ABSTRACT

A foot-controlled personal transportation device having a drive wheel and a foot platform, with the drive wheel preferably located below the platform. Device driving may be controlled by a position sensor and a control circuit that drives the device toward auto-balancing. Various components and embodiments are disclosed including, but not limited to, a single wheel structure having various configurations, one-foot and two-feet platform embodiments, various sensor and drive arrangements, and coaxial wheel driving using a hub motor or the like.

### CROSS REFERENCE TO RELATED APPLICATIONS

This application claims the benefit of U.S. Provisional Application No. 62/469,514, filed Mar. 9, 2017, and entitled Self-Balancing Transportation Device with Single Foot Foot Platform, by the inventor above.

### FIELD OF THE INVENTION

The present invention relates to personal transportation devices and, more specifically, to such devices with under platform drive wheels and/or single-foot foot platforms.

### BACKGROUND OF THE INVENTION

The prior art includes U.S. Pat. No. 8,738,278 issued to Shane Chen (the inventor herein) for a Two-Wheel, Self-Balancing Vehicle with Independently Movable Foot Placement Sections. This patent is hereby incorporated by reference as though disclosed in its entirety herein. The '278 patent teaches fore-aft self-balancing of two movable foot platforms, as well as drive motors, control circuitry, and related components.

In the '278 patent, the foot platforms are coupled to one another and although separately rotatable in fore-aft, they are maintained in a fixed parallel relationship. There is no independent movement laterally or longitudinally relative to one another.

A need exists for auto-balancing transportation devices that allow this lateral and/or longitudinal movement relative to one another. These devices could accommodate each foot separately and thus function as “single-foot” devices. A need also exists for configuring these devices with a low or smaller profile, including arranging the drive wheel under the foot platform, thereby creating platforms that may be mounted or dismounted without (or with very little) obstruction.

An auto-balancing device having separate single-foot foot platforms, and particularly one with the drive wheel under the foot platform, would provide several benefits. These include accommodating riders of different size and foot spacing preferences and enhancing the riding experience by allowing riders to freely move their legs and feet forward-backward and/or side-to-side. The independent foot movement also permits a rider to navigate around obstacles and through narrow pathways, and to encounter bumps in series (one after the other) rather than in parallel (both wheels at the same time) which is usually more stable.

Another benefits of two separate smaller units compared, for example, to the bulk of Hovertrax type devices and the even larger Segwey type devices, is that the single-foot foot platform devices of the present invention are relatively small and lightweight. This makes them easy to carry or stow, for example, at work, on a bus, or at home. This latter benefit may be particularly important in making low profile single-foot devices a viable commuter option.

Notwithstanding the benefits of a single-foot auto-balancing device, the prior art teaches away from making or using such a device. Early auto-balancing devices include the Segwey. These devices relied on a large, erect handlebar structure through which a rider controlled the driving of the wheels. Since auto-balancing devices tend to give riders a sense of lack-of-control (at least initially), the handlebar structure both achieved device driving and allayed some the inherent safety concerns of a rider.

Later came the device of Simeray disclosed in U.S. Pat. No. 8,616,313. This device dispensed with the handlebar but required leg clamps that “tightly hold the calf and the leg.” The leg clamps were considered necessary to achieve adequate control. It was later shown that leg clamps are unnecessary, but their promotion at the time is evidence of the mindset in the field that control is problematic and exceptional control measures are required.

The Solowheel and Hovertrax U.S. Pat. Nos. 8,807,250 and 8,738,278, respectively) taught that auto-balancing devices could indeed be adequately operated by foot-control alone (or with optional additional lower leg control in the case of Solowheel). These devices, however, teach fixed position foot platforms. While the platforms of the Hovertrax may rotate in fore-aft relative to one another, their spacing laterally and longitudinally does not change. The device, however, is laterally stable due to the placement of the wheels outside the platforms.

In the Solowheel device, there is less lateral stability because the wheel structure is centrally located, but there is no movement of the foot platforms relative to one another. In single-foot foot platform devices, a fixed relationship between the foot platforms is not available, nor is the stability and control it provides.

In 2009, Nissan announced a personal mobility device that has a single-foot foot platform, though it is unclear if this device is auto-balancing or otherwise driven (pressure sensor, handheld control, other). This device does teach the use of a control shaft and handle (that resembles a ski pole) coupled to the each elevated platform. This pole based structure is disadvantageous in many ways, including that the pole get in the way, a rider cannot readily bend at the knee, and it is difficult to control balance and direction distally through a poles, etc. Other issues include drive mechanism, battery size and life, speed (limited to 3 mph), wheel size, and the ability to traverse bumps, etc. For safety and comfort, foot platforms are usually low to the ground (for mounting/dismounting) which significant limits the amount of space available for components.

Nishikawa, U.S. Pat. No. 7,481,291, in FIG. 10, also discloses a single-foot foot platform device, but this device is not auto-balancing, includes large wheels that would obstruct mounting and dismounting, and does not teach an under platform drive wheel structure.

A need thus exists for a low profile, preferably auto-balancing, personal transportation device that may accommodate a single foot. A rider using two of these devices, one on each foot, could then experience auto-balance driven travel with the benefits of independent foot movement. A need also exists for a low profile personal transportation device in which the device drive wheel is located under the foot platform, among other needs.

### SUMMARY OF THE INVENTION

Accordingly, it is an object of the present invention to provide a foot-controlled personal transportation device.

It is also an object of the present invention to provide a single-foot foot platform personal transportation device.

It is another object of the present invention to provide a personal transportation device in which the drive wheel is located under the foot platform.

These and related objects of the present invention are achieved by use of a foot-controlled personal transportation device as described herein.

The attainment of the foregoing and related advantages and features of the invention should be more readily apparent to those skilled in the art, after review of the following more detailed description of the invention taken together with the drawings.

### BRIEF DESCRIPTION OF THE DRAWINGS

FIGS. 1-2 are perspective views of a pair of single-foot foot platform personal transportation devices in accordance with the present invention.

FIGS. 3-4 are perspective views of a single-foot foot platform device of FIGS. 1-2 with the foot platform raised.

FIGS. 5-6 are perspective views of a foot-controlled personal transportation device in accordance with the present invention.

### DETAILED DESCRIPTION

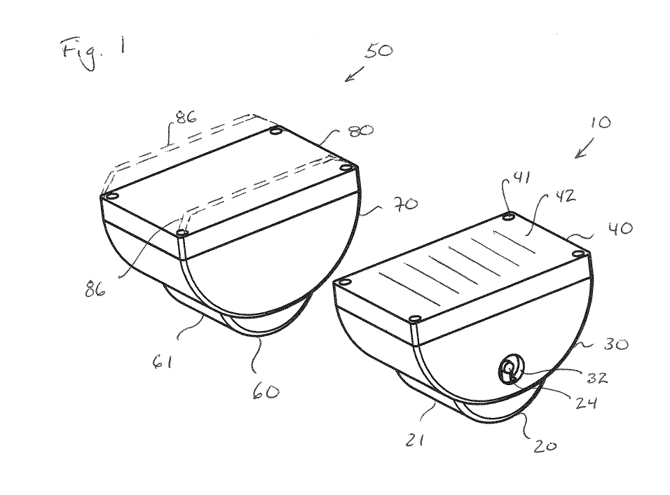

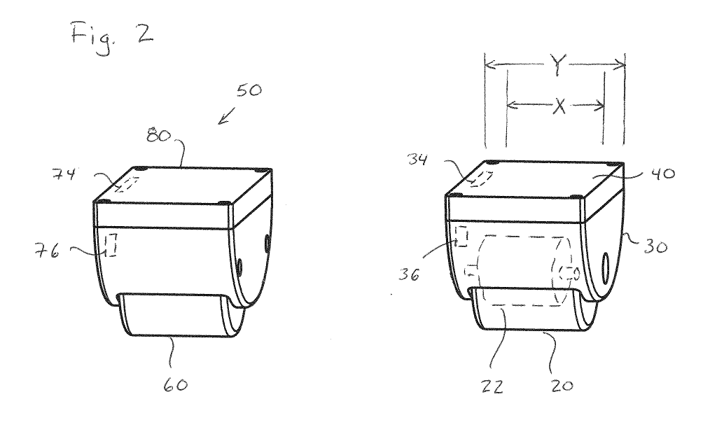

Referring to FIGS. 1-2, perspective views of a pair of single-foot foot platform auto-balancing transportation devices 10,50 in accordance with the present invention are shown. Devices 10,50 are substantially the same and may be used interchangeably (by the left or the right foot, and forward or backward). That said, paired single-foot foot platform devices within the present invention may be configured specifically for the left and right foot, similar to shoes, without departing from the present invention.

Device 10 preferably has a wheel 20, a casing 30 and a platform 40. Wheel 20 is preferably driven by a hub motor 22 (shown in phantom lines in FIG. 2). Motor 22 may have a pair of mounting rods 24 that couple to brackets 32 which are fixedly coupled to casing 30. In this manner, the motor and wheel are securely coupled to the casing. Mounting rods 24 are preferably arranged coaxially with the axis of rotation of wheel 20. Thus, in this embodiment, the axis of rotation of the motor and the wheel are the same. Wheel 20 may also include a tire or other exteriorly-disposed traction enhancing and/or shock absorbing material 21.

Foot platform 40 may be fastened by fasteners 41 to casing 30. A water-tight seal is preferably provided that protects the components internal to the platform and casing enclosure. Tread (rubber or other), grip tape (as used on skateboards) or other friction increasing material 42 may be applied to the top surface of platform 40.

Device 50 also preferably includes a wheel 60, a casing 70 and a platform 80. Wheel 60 may include a tire or the like and is preferable driven by a similarly mounted hub motor. These and related components may be configured as their counterparts in device 10. FIG. 1 illustrates that sidewalls 86 may ascend from platform 80. Sidewalls may assist in device control by allowing a rider to exert pressure on them with his or her foot. The sidewalls are illustrated in phantom lines because they are optional. While shown on only one device, they may be provided with any device herein. Also, they may have different shapes without deviating from the present invention. A low side wall, however, creates less obstruction for mounting or dismounting the device.

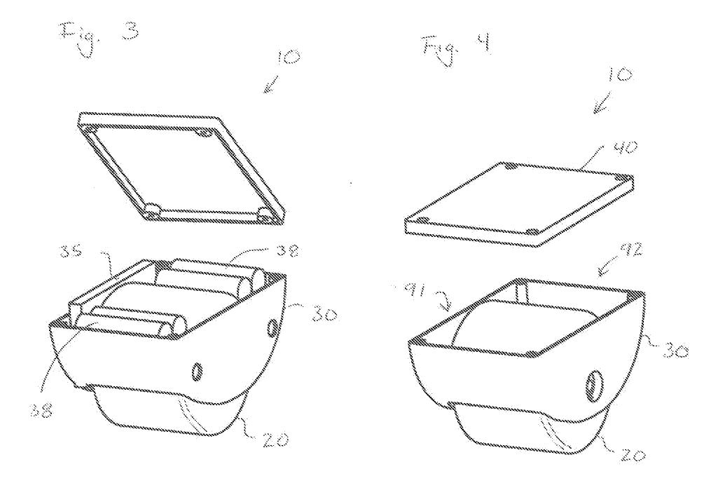

Device 10 preferably includes a position sensor 34, a control circuit 36, a battery 38 (shown in FIG. 3), and drive motor 22. Position sensor 34 is preferably a gyroscopic sensor. It is capable of sensing fore-aft pitch and may sense sideways tilt, among other measures. In response to a forward pitch angle, the device is driven forward and in response to a rearward pitch angle, it is driven in reverse. The speed is based on the magnitude of the pitch angle. Auto-balancing components and techniques are known in the art.

Device 50 similarly includes a position sensor 74, a control circuit 76, a battery 78 and a drive motor (obscured from view, but represented by drive motor 22). Device 50 operates in a manner similar to device 10.

Thus, devices 10,50 are effectively stand-alone auto-balancing transportation devices.

In the embodiments of FIGS. 1-2, the platforms may be 3-4″ wide (laterally) and 6-8″ long (longitudinally), or other.

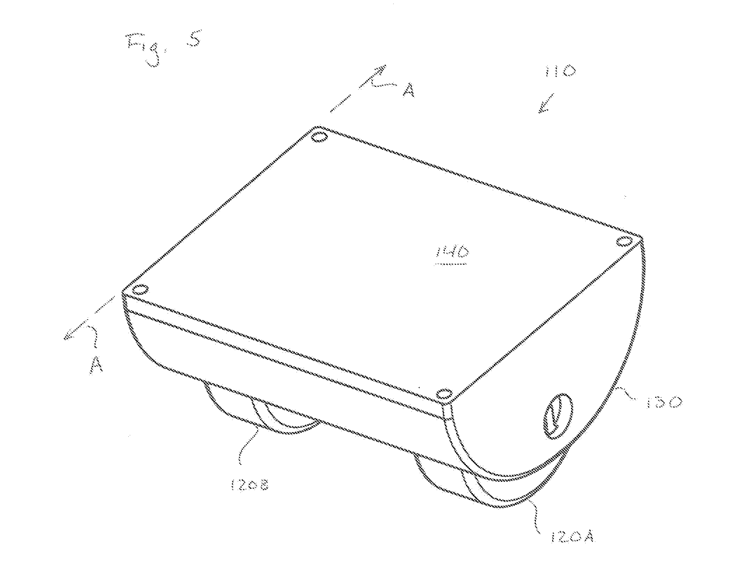

Referring to FIGS. 3 and 4, perspective views of device 10 with platform 40 raised are shown. Since platform 40 extends longitudinally and casing 30 extends between wheel 20 and the edges of the platform, two volumes or cavities 91,92 are formed (FIG. 4), one each on opposite longitudinal sides of the wheel. A thin volume may also exist on the lateral sides of wheel 20 depending on the shape of the housing and the wheel.

Batteries 38 are preferably placed in one or both of volumes 91,92. A circuit board 35 may be placed in the thin cavity on a lateral side of wheel 20 (FIG. 3). Position sensor 34 and control circuit 36 are preferably placed on this circuit board. In this manner, the components of device 10 are efficiently arranged in the small available volume.

While two volumes 91,92 are shown formed by a single casing, it should be recognized that the components and casing could be otherwise arranged without departing from the present invention. For example, two separate casing sections could descend from the underside of the platforms. Further, as battery size decreases with advances in battery technology, the components and shape of casing 30 may be otherwise arrange. With respect to casing 30, the shape of the casing may be otherwise arranged, regardless of decreases in battery size, without departing from the present invention. For example, the casing could be more tapered or fluted, or rounded longitudinally, or otherwise functionally or artistically rendered.

Device 50 is preferably arranged internally in the same manner as device 10.

Wheels 20,60 are preferably centered laterally (or substantially so) to enhance lateral balance and are generally wide to enhance lateral stability. FIG. 2 illustrates a wheel width of X and a foot platform width of Y. Preferably X is 50-100% of Y, though it may be less than 50% or more than 100% (with an extension mounting bracket or split wheel structure or the like) without departing from the present invention. More preferably, X may be 60-95% of Y or 70-90% of Y.

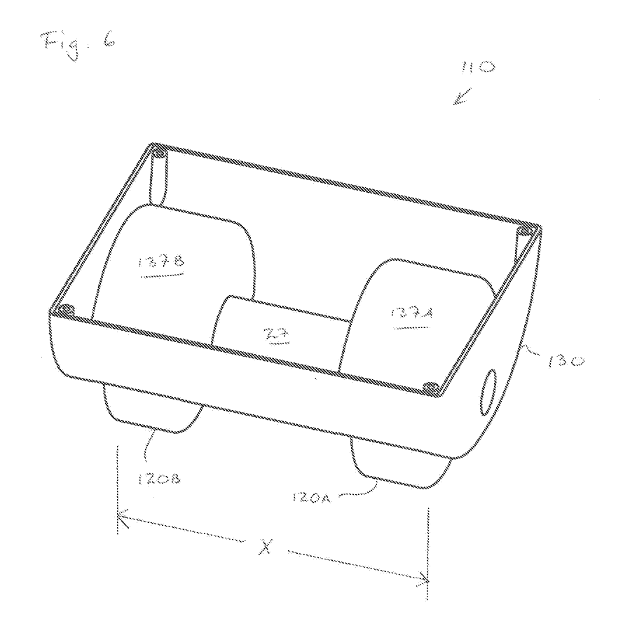

Referring to FIGS. 5-6, perspective views of another embodiment of a foot-controlled personal transportation device 110 in accordance with the present invention are shown.

Similar to device 10, device 110 includes wheels 120A,120B, a casing 130 and a platform 140. Device 110 also preferably includes a sensor, control circuit and battery as discussed above. FIG. 5 illustrates device 110 with the platform on and FIG. 6 with the platform removed.

In contrast to the single wheel of device 10, device 110 includes two wheels 120A,120B. These wheels are preferably coupled together by an axle shaft or the like within casing section 127 such that if one wheel turns, the other does as well. A hub motor is preferably provided with wheel 120A and thus as wheel 120A is driven, so is wheel 120B. A non-hub motor (or a modified hub motor) may also be used, and it may be placed between the wheels. This motor may be axially arranged or other.

The term “single wheel structure” is used herein to refer to a single wheel such as wheel 20 of FIG. 1 and to a paired or multiple coupled wheels where movement among the wheels is the same, such as with coupled wheels 120A,120B (i.e., the wheels function as a single wide wheel).

The coupled wheels of FIG. 5 allow for a wide overall wheel width, X, from the outside edge of one wheel to the outside edge of the other. A wide X provides enhanced lateral stability.

The dimensions of device 110 may be larger than those of device 10. In device 110, as shown, the width of the device may be wider than long. This would allow a rider to stand with both feet on platform 140, likely facing forward. Platform 140 may also be extended longitudinally in the directions of Arrows A. Extending the platform in this dimension would allow a rider to stand comfortably, sideways, with both feet on platform 140, or to stand somewhere in between straight-forward and sideways. Hence, it is possible to configure the present invention for riding with a single foot or both feet. Furthermore, for example, if platform 140 is extended in direction A and overhangs casing 130, then a handle (formed by an opening in the overhanging portion) could readily be formed in the platform making the device easy to pick up, carry and put down.

While wheels 120A,120B were described above as part of single wheel structure and driven by a single motor, it should be recognized that those wheels could be driven by separate motors and at different speeds. For example, they may be arranged coaxially, yet without a common axle, and pressure sensors may be provided on platform 140 in addition to the position sensor within the device. The position sensor could detect fore-aft pitch for general driving, and the pressure sensors could detect lateral weight shift and afford turning by adjusting the speed of each wheel (based on weight distribution) to affect a turn.

It should also be recognized that while auto-balaning is a preferred technique for devices 10,110, devices may use pressure sensors or torsion sensors or other sensors, individually or in various combinations, without departing from the drive wheel under foot platform, single-foot foot platform, and/or other inventive aspects of the present invention.

While the invention has been described in connection with specific embodiments thereof, it will be understood that it is capable of further modification, and this application is intended to cover any variations, uses, or adaptations of the invention following, in general, the principles of the invention and including such departures from the present disclosure as come within known or customary practice in the art to which the invention pertains and as may be applied to the essential features hereinbefore set forth, and as fall within the scope of the invention and the limits of the appended claims.

1. A transportation device, comprising:
a foot platform;
a wheel structure;
a motor that drives the wheel structure;
a sensor; and
a control circuit that drives the motor based on data from the sensor;
wherein the wheel structure is located below the foot platform.

2. The device of claim 1, wherein the motor is a hub motor.

3. The device of claim 1, wherein the axis of rotation of the motor is coaxial with the axis of rotation of the wheel structure.

4. The device of claim 1, further comprising a casing having a first section extending longitudinally from one side of the wheel structure to the platform and a second section extending longitudinally from another side of the wheel structure to the platform, the first section defining a first volume and the second section defining a second volume.

5. The device of claim 1, further comprising at least a first casing extending longitudinally from one side of the wheel structure.

6. The device of claim 1, wherein the foot platform has greater longitudinal dimension than lateral dimension.

7. The device of claim 1, wherein the wheel structure has a wheel lateral width and the foot platform has a platform lateral width vertically above the axis of rotation of the wheel structure, and the wheel lateral width is half or more the platform lateral width.

8. The device of claim 7, wherein the wheel lateral width is two-thirds or more the platform lateral width.

9. The device of claim 1, wherein the wheel structure includes a single wheel.

10. The device of claim 1, wherein the sensor is a position sensor capable of sensing fore-aft pitch angle.

11. The device of claim 1, wherein the device is configured for handless control.

12. An auto-balancing transportation device, comprising:
a singular foot platform;
a wheel structure;
a hub motor that drives the wheel structure;
a sensor; and
a control circuit that drives the motor based on data from the sensor;
wherein the foot platform has a greater longitudinal dimension than lateral dimension; and
wherein the device is configured for hand-free control.

13. The device of claim 12, wherein the motor and wheel structure are located under the foot platform.

14. The device of claim 12, wherein the wheel structure is laterally centered under the foot platform.

15. The device of claim 12, wherein the wheel structure has a wheel lateral width and the foot platform has a platform lateral width vertically above the axis of rotation of the wheel structure, and the wheel lateral width is half or more the platform lateral width.

16. An auto-balancing transportation device, comprising:
a foot platform;
a wheel structure coupled to the foot platform;
a motor that drives the wheel structure;
a sensor; and
a control circuit that drives the motor towards auto-balancing the device based on data from the sensor;
wherein the wheel structure is located below the foot platform.

17. The device of claim 16, wherein the foot platform has a greater longitudinal dimension than lateral dimension.

18. The device of claim 16, wherein the wheel structure is substantially laterally centered under the foot platform.

19. The device of claim 16, wherein the wheel structure has a wheel lateral width and the foot platform has a platform lateral width vertically above the axis of rotation of the wheel structure, and the wheel lateral width is half or more the platform lateral width.

20. The device of claim 16, further comprising at least a first casing extending longitudinally from one side of the wheel structure.
